(19) United States
(12) Patent Application Publication
(10) Pub. No.: US 2023/0314589 A1
(43) Pub. Date: Oct. 5, 2023

(54) CONTROL DEVICE, COMMUNICATION DEVICE, AND INFORMATION PROCESSING METHOD

(71) Applicant: KABUSHIKI KAISHA TOKAI RIKA DENKI SEISAKUSHO, Aichi (JP)

(72) Inventors: Yutaka KUBO, Aichi (JP); Shigenori NITTA, Aichi (JP); Masateru FURUTA, Aichi (JP); Yuki KONO, Aichi (JP); Yosuke OHASHI, Aichi (JP)

(73) Assignee: KABUSHIKI KAISHA TOKAI RIKA DENKI SEISAKUSHO, Aichi (JP)

(21) Appl. No.: 18/008,357

(22) PCT Filed: Feb. 1, 2021
(86) PCT No.: PCT/JP2021/003573

§ 371 Date: Dec. 5, 2022

(30) Foreign Application Priority Data
Jun. 30, 2020 (JP) 2020-112587

(51) Int. Cl. G01S 13/76

(52) U.S. Cl. CPC G01S 13/765

(57) ABSTRACT

A control device including a control section configured to obtain distance measurement information, and perform a process according to the obtained distance measurement information, the distance measurement information being information that is obtained by transmitting and receiving a distance measurement signal between at least two communication devices, and the distance measurement signal being a signal that is transmitted and received to measure a distance between the two communication devices.

### TECHNICAL FIELD

The present invention relates to a control device, a communication device, and an information processing method.

### BACKGROUND ART

In recent years, various technologies for measuring distances (also referred to as distance measurement below) between devices have been developed. For example, following Patent Literature 1 discloses a technology that measures a distance between devices based on a period from transmission of a signal to reception of a response to this signal.

### CITATION LIST

### Patent Literature

Patent Literature 1: JP H11-208419

### SUMMARY OF INVENTION

### Technical Problem

However, according to the technology disclosed in above Patent Literature 1, one of two devices that have transmitted and received a signal only measures and uses a distance, and therefore lacks in applicability.

Accordingly, the present invention is made in view of the aforementioned issues, and an object of the present invention is to provide a mechanism that makes it possible to improve applicability of a distance measurement technology.

### Solution to Problem

To solve the above described problem, according to an aspect of the present invention, there is provided a control device comprising a control section configured to obtain distance measurement information, and perform a process according to the obtained distance measurement information, the distance measurement information being information that is obtained by transmitting and receiving a distance measurement signal between at least two communication devices, and the distance measurement signal being a signal that is transmitted and received to measure a distance between the two communication devices.

To solve the above described problem, according to another aspect of the present invention, there is provided a communication device comprising: a wireless communication section configured to perform wireless communication with another communication device; and a control section configured to control a process of transmitting distance measurement information to a control device configured to execute communication with each of the communication device and the another communication device, the distance measurement information being information that is obtained by transmitting and receiving a distance measurement signal between the wireless communication section and the another communication device, and the distance measurement signal being a signal that is transmitted and received to measure a distance between the two communication devices.

To solve the above described problem, according to another aspect of the present invention, there is provided an information processing method comprising obtaining distance measurement information, and performing a process according to the obtained distance measurement information, the distance measurement information being information that is obtained by transmitting and receiving a distance measurement signal between at least two communication devices, and the distance measurement signal being a signal that is transmitted and received to measure a distance between the two communication devices.

To solve the above described problem, according to another aspect of the present invention, there is provided an information processing method that is executed by a communication device configured to perform wireless communication with another communication device, the information processing method comprising controlling a process of transmitting distance measurement information to a control device configured to execute communication with each of the communication device and the another communication device, the distance measurement information being information that is obtained by transmitting and receiving a distance measurement signal between the wireless communication section and the another communication device, and the distance measurement signal being a signal that is transmitted and received to measure a distance between the two communication devices.

### Advantageous Effects of Invention

As described above, the present invention provides a mechanism that makes it possible to improve applicability of a distance measurement technology.

### BRIEF DESCRIPTION OF DRAWINGS

FIG. 1 is a diagram illustrating an example of a configuration of a system according to an embodiment of the present invention.

FIG. 2 is a sequence diagram illustrating an example of a flow of a typical distance measurement process.

FIG. 3 is a sequence diagram illustrating an example of a flow of a process executed by the system according to the present embodiment.

### DESCRIPTION OF EMBODIMENTS

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Configuration Example

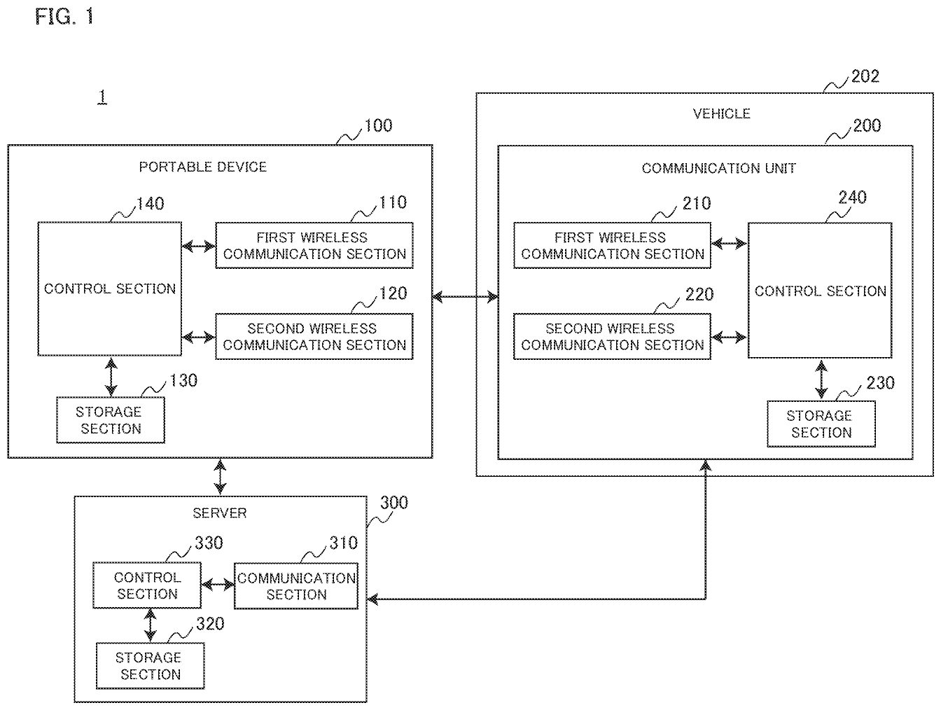

FIG. 1 is a diagram illustrating an example of a configuration of a system 1 according to an embodiment of the present invention. As illustrated in FIG. 1, the system 1 according to the present embodiment includes a portable device 100, a communication unit 200, and a server 300. The communication unit 200 according to the present embodiment is mounted on a vehicle 202. The vehicle 202 is an example of a use target of a user.

In the system 1, when the user (e.g., a driver of the vehicle 202) approaches the vehicle 202 carrying the portable device 100, the portable device 100 and the communication unit 200 perform wireless communication for authentication. Furthermore, when authentication succeeds, a door lock of the vehicle 202 is unlocked or an engine is started, and the vehicle 202 becomes available for the user. The system 1 is also referred to as a smart entry system. Each component will be described below in order.

(1) Portable Device 100

The portable device 100 is a communication device that performs wireless communication with the communication unit 200. The portable device 100 is configured as an arbitrary device that is carried and used by the user. An example of the arbitrary device includes an electronic key, a smartphone, and a wearable terminal. As illustrated in FIG. 1, the portable device 100 includes a first wireless communication section 110, a second wireless communication section 120, a storage section 130, and a control section 140.

The first wireless communication section 110 has a function of performing wireless communication for communicating with the server 300. For example, the first wireless communication section 110 performs wireless communication that conforms to wireless communication standards of a cellular system such as Long Term Evolution (LTE) with a base station. Furthermore, the first wireless communication section 110 communicates with the server 300 by wireless communication with the base station.

The second wireless communication section 120 has a function of performing wireless communication with the communication unit 200. For example, the second wireless communication section 120 transmits and receives signals that use an Ultra-Wide Band (UWB). Using an impulse system during wireless communication of the signals that use the UWB makes it possible to precisely measure a radio wave propagation time by using a radio wave of a very short pulse width equal to or less than nano seconds, and precisely measure a distance based on the propagation time.

The storage section 130 has a function of storing various pieces of information for operations of the portable device 100. For example, the storage section 130 stores, for example, programs for the operations of the portable device 100. The storage section 130 includes, for example, a storage medium such as a flash memory, and a processing device that executes recording and playback with respect to a storage medium.

The control section 140 has a function of executing a process in the portable device 100. For example, the control section 140 controls the first wireless communication section 110, and communicates with the server 300. Furthermore, the control section 140 controls the second wireless communication section 120, and communicates with the communication unit 200. Furthermore, the control section 140 reads information from the storage section 130, and writes information in the storage section 130. The control section 140 is configured as an electronic circuit such as a Central Processing Unit (CPU) and a microprocessor.

(2) Communication Unit 200

The communication unit 200 is a communication device that performs wireless communication with the portable device 100. The communication unit 200 is provided in association with the vehicle 202. In this regard, the communication unit 200 is, for example, installed inside a vehicle compartment of the vehicle 202 or built in the vehicle 202 as a communication module, that is, the communication unit 200 is mounted on the vehicle 202. As illustrated in FIG. 1, the communication unit 200 includes a first wireless communication section 210, a second wireless communication section 220, a storage section 230, and a control section 240.

The first wireless communication section 210 has a function of performing wireless communication for communicating with the server 300. For example, the first wireless communication section 210 is configured as a Data Communication Module (DCM). The DCM is an in-vehicle equipment dedicated communication device. The first wireless communication section 210 communicates with the server 300 by wireless communication with the base station.

The second wireless communication section 220 has a function of performing wireless communication with the portable device 100. For example, the second wireless communication section 120 transmits and receives signals that use the UWB.

The storage section 230 has a function of storing various pieces of information for operations of the communication unit 200. For example, the storage section 230 stores, for example, programs for the operations of the communication unit 200. The storage section 230 includes, for example, a storage medium such as a flash memory, and a processing device that executes recording and playback with respect to a storage medium.

The control section 240 has a function of controlling all operations of the communication unit 200 and pieces of in-vehicle equipment mounted on the vehicle 202. In an example, the control section 240 controls the first wireless communication section 210, and communicates with the server 300. Furthermore, the control section 240 controls the second wireless communication section 220, and communicates with the portable device 100. Furthermore, the control section 240 reads information from the storage section 230, and writes information in the storage section 230. Furthermore, the control section 240 functions as a door lock control section that controls the door lock of the vehicle 202, and locks and unlocks the door lock. Furthermore, the control section 240 functions as an engine control section that controls the engine of the vehicle 202, and starts/stops the engine. Note that a power supply equipped to the vehicle 202 may be, for example, a motor in addition to the engine. The control section 240 is configured as, for example, an Electronic Control Unit (ECU).

(3) Server 300

The server 300 is a device that executes communication with each of the portable device 100 and the communication unit 200. The server 300 is an example of a control device. As illustrated in FIG. 1, the server 300 includes a communication section 310, a storage section 320, and a control section 330.

The communication section 310 has a function of performing communication with each of the portable device 100 and the communication unit 200.

The storage section 320 has a function of storing various pieces of information for operations of the server 300. For example, the storage section 320 stores, for example, programs for the operations of the server 300. The storage section 320 includes, for example, a storage medium such as a Hard Disc Drive (HDD) and a Solid State Drive (SSD), and a processing device that executes recording and playback with respect to the storage medium.

The control section 330 has a function of executing a process in the server 300. For example, the control section 330 controls the communication section 310, and communicates with each of the portable device 100 and the communication unit 200. Furthermore, the control section 330 reads information from the storage section 320, and writes information in the storage section 320. Furthermore, the control section 330 executes a process that is based on information obtained from each of the portable device 100 and the communication unit 200. The control section 330 is configured as, for example, an electronic circuit such as a Central Processing Unit (CPU) and a microprocessor.

<2. Technical Feature>

(1) Distance Measurement Process

The system 1 executes a distance measurement process. The distance measurement process is a process of measuring a distance between the portable device 100 and the communication unit 200. The distance measured by the distance measurement process is also referred to as a distance measurement value below.

During the distance measurement process, a signal can be wirelessly transmitted and received.

An example of the signal that is transmitted and received during the distance measurement process is a distance measurement signal. The distance measurement signal is a signal that is transmitted and received to measure a distance between two devices. The distance measurement signal is also a measurement target signal. For example, a time taken to transmit and receive the distance measurement signal is measured. Typically, the distance measurement signal includes a frame format that does not have a payload part in which data is stored. Naturally, the distance measurement signal may include a frame format that has a payload part in which data is stored.

During the distance measurement process, a plurality of distance measurement signals can be transmitted and received between the devices. The distance measurement signal transmitted from the one device to the other device among the plurality of distance measurement signals is also referred to as a first distance measurement signal. Furthermore, the distance measurement signal transmitted from the device that has received the first distance measurement signal to the device that has transmitted the first distance measurement signal is also referred to as a second distance measurement signal.

Another example of the signal that is transmitted and received during the distance measurement process is a data signal. The data signal is a signal in which data is stored to convey. The data signal includes a frame format that has a payload part in which data is stored.

Transmitting and receiving a signal between two devices whose distance is measured by the distance measurement process is also referred to as distance measurement communication below. In the present embodiment, the second wireless communication section 120 and the second wireless communication section 220 perform distance measurement communication. According to the distance measurement process, a distance between the second wireless communication section 120 and the second wireless communication section 220 that have performed the distance measurement communication is measured as a distance between the portable device 100 and the communication unit 200.

Note that the distance measurement value can be used to authenticate the portable device 100. When, for example, the distance measurement value is less than a predetermined threshold, it is decided that authentication has succeeded. On the other hand, when the distance measurement value is the predetermined threshold or more, it is decided that authentication has failed.

A typical distance measurement process will be described below. The typical distance measurement process is a distance measurement process in which only two devices that transmit and receive a distance measurement signal are involved.

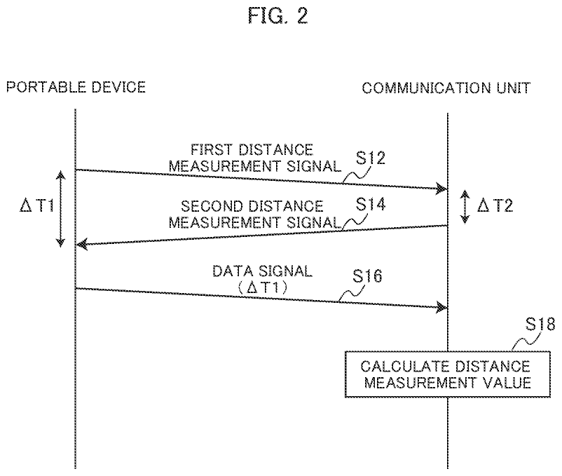

FIG. 2 is a sequence diagram illustrating an example of a flow of the typical distance measurement process. As illustrated in FIG. 2, a portable device and a communication unit are involved in this sequence. Note that the portable device and the communication unit in this sequence employ the same configurations as those of the portable device 100 and the communication unit 200 described above with reference to FIG. 1.

As illustrated in FIG. 2, the portable device first transmits a first distance measurement signal (step S12). For example, the first distance measurement signal may be transmitted as a signal that uses the UWB.

Next, when receiving the first distance measurement signal from the portable device, the communication unit transmits a second distance measurement signal as a response to the first distance measurement signal (step S14). For example, the second distance measurement signal may be transmitted as a signal that uses the UWB.

In this case, the communication unit measures a time ΔT2 from a reception time of the first distance measurement signal to a transmission time of the second distance measurement signal in the communication unit. On the other hand, when receiving the second distance measurement signal from the communication unit, the portable device measures a time ΔT1 from a transmission time of the first distance measurement signal to a reception time of the second distance measurement signal in the portable device.

Next, the portable device transmits a data signal that includes information that indicates the time ΔT1 (step S16). For example, the data signal may be transmitted as a signal that uses the UWB.

Furthermore, when receiving the data signal, the communication unit calculates a distance measurement value that indicates a distance between the portable device and the communication time based on ΔT1 indicated by information included in the data signal and the measured time ΔT2 (step S18). More specifically, the communication unit calculates a one-way signal propagation time by dividing a result of ΔT1−ΔT2 by 2. Furthermore, the communication unit calculates the distance measurement value that indicates the distance between the portable device and the communication unit by multiplying this propagation time with a signal speed.

### (2) Technical Problem

According to the typical distance measurement process described above with reference to FIG. 2, the data signal that includes the information that indicates the time ΔT1 is transmitted from the portable device to the communication unit. Taking into account that communication between the portable device and the communication unit can be eavesdropped, it can be said that there is a room for improvement of a security level.

Furthermore, it is also conceived to transmit the data signal transmitted from the portable device to the communication unit as a signal of an Ultra-High Frequency (UHF) band instead of the signal that uses the UWB. The UHF band is a frequency band used for communication between in-vehicle equipment and dedicated equipment that communicates with the in-vehicle equipment. However, a function of transmitting and receiving signals of the UHF band is not mounted on general-purpose equipment such as a smartphone. Therefore, it is difficult to use the general-purpose equipment such as a smartphone as the portable device that transmits the data signal as the signal of the UHF band.

Hence, the present embodiment proposes the distance measurement process in which a device other than the two devices that transmit and receive distance measurement signals is involved. More specifically, in addition to the portable device 100 and the communication unit 200, the server 300 is involved in the distance measurement process according to the present embodiment. The distance measurement process according to the present embodiment will be described in more detail below.

### (3) Distance Measurement Process According to Present Embodiment

The server 300 obtains distance measurement information that is information obtained by transmitting and receiving the distance measurement signal between at least the two communication devices, and performs a process according to the obtained distance measurement information. Examples of the communication devices that transmit and receive the distance measurement signal are the portable device 100 and the communication unit 200.

In one example, the portable device 100 transmits to the server 300 the information obtained by transmitting and receiving the distance measurement signal to and from the communication unit 200 as the distance measurement information. On the other hand, the portable device 100 does not transmit to the communication unit 200 the distance measurement information obtained by transmitting and receiving the distance measurement signal to and from the communication unit 200.

In another example, the communication unit 200 transmits to the server 300 the information that is obtained by transmitting and receiving the distance measurement signal to and from the portable device 100 as the distance measurement information. On the other hand, the communication unit 200 does not transmit to the portable device 100 the distance measurement information obtained by transmitting and receiving the distance measurement signal to and from the portable device 100.

According to this configuration, the server 300 can receive (that is, obtain) the distance measurement information. Furthermore, the server 300 performs the process according to the distance measurement information obtained by transmitting and receiving the distance measurement signal between the portable device 100 and the communication unit 200. According to this configuration, the information obtained by transmitting and receiving the distance measurement signal between the portable device 100 and the communication unit 200 can be used by the server 300 that is a device other than the portable device 100 and the communication unit 200. From such a viewpoint, it is possible to improve applicability of a distance measurement technology.

An example of the information included in the distance measurement information will be described.

The distance measurement information is information that is obtained when a first communication device that is one of the two communication devices transmits the first distance measurement signal, an other second communication device receives the first distance measurement signal, the second communication device transmits the second distance measurement signal as a response to the first distance measurement signal, and the first communication device receives the second distance measurement signal. The portable device 100 is an example of the first communication device. The communication unit 200 is an example of the second communication device. In an example, the portable device 100 transmits to the server 300 the information obtained by transmitting the first distance measurement signal and/or receiving the second distance measurement signal as the distance measurement information. In another example, the communication unit 200 transmits to the server 300 the information obtained by receiving the first distance measurement signal and/or transmitting the second distance measurement signal as the distance measurement information. According to this configuration, the server 300 can receive (that is, obtain) the information obtained by transmitting and receiving the first distance measurement signal and the second distance measurement signal as the distance measurement information. Consequently, the server 300 can calculate a distance measurement value that indicates a distance between the portable device 100 and the communication unit 200 based on the obtained distance measurement information.

The distance measurement information may include information that indicates a time (i.e., ΔT1) from a transmission time of the first distance measurement signal to a reception time of the second distance measurement signal in the portable device 100. For example, the portable device 100 transmits to the server 300 the distance measurement information that includes the information that indicates the time (i.e., ΔT1) from the transmission time of the first distance measurement signal to the reception time of the second distance measurement signal in the portable device 100. Consequently, the server 300 can obtain the information that indicates the time ΔT1. On the other hand, the server 300 additionally obtains information that indicates a time (i.e., ΔT2) from a reception time of the first distance measurement signal to a transmission time of the second distance measurement signal in the communication unit 200. For example, as described below, the information that indicates the time ΔT2 can be included in the distance measurement information transmitted by the communication unit 200 to the server 300. In this case, the server 300 can calculate the distance measurement value based on the time ΔT1 included in the received distance measurement information and the additionally obtained time ΔT2.

The distance measurement information may include information that indicates the transmission time of the first distance measurement signal and the reception time of the second distance measurement signal in the portable device 100. For example, the portable device 100 transmits to the server 300 the distance measurement information including the information that indicates the transmission time of the first distance measurement signal and the reception time of the second distance measurement signal in the portable device 100. In this case, the server 300 can calculate the time (i.e., ΔT1) from the transmission time of the first distance measurement signal to the reception time of the second distance measurement signal in the portable device 100 based on the received distance measurement information. Consequently, the server 300 can calculate the distance measurement value based on the calculated time ΔT1 and the additionally obtained time ΔT2.

The distance measurement information may include information that indicates the time (i.e., ΔT2) from the reception time of the first distance measurement signal to the transmission time of the second distance measurement signal in the communication unit 200. For example, the communication unit 200 transmits to the server 300 the distance measurement information including the information that indicates the time (i.e., ΔT2) from the reception time of the first distance measurement signal to the transmission time of the second distance measurement signal in the communication unit 200. Consequently, the server 300 can obtain the information that indicates the time ΔT2. On the other hand, the server 300 can additionally obtain the information that indicates the time (i.e., ΔT1) from the transmission time of the first distance measurement signal to the reception time of the second distance measurement signal in the portable device 100. For example, as described above, the information that indicates the time ΔT1 can be included in the distance measurement information transmitted by the portable device 100 to the server 300. In this case, the server 300 can calculate the distance measurement value based on the time ΔT2 included in the received distance measurement information and the additionally obtained time ΔT1.

The distance measurement information may include information that indicates the reception time of the first distance measurement signal and the transmission time of the second distance measurement signal in the communication unit 200. For example, the communication unit 200 transmits to the server 300 the distance measurement information including the information that indicates the reception time of the first distance measurement signal and the transmission time of the second distance measurement signal in the communication unit 200. In this case, the server 300 can calculate the time (i.e., ΔT2) from the reception time of the first distance measurement signal to the transmission time of the second distance measurement signal in the communication unit 200 based on the received distance measurement information. Consequently, the server 300 can calculate the distance measurement value based on the calculated time ΔT2 and the additionally obtained time ΔT1.

The example of the information included in the distance measurement information has been described above.

The server 300 performs the process according to the distance measurement information by calculating the distance measurement value that indicates the distance between the portable device 100 and the communication unit 200 based on the distance measurement information. More specifically, the server 300 obtains the time ΔT1 based on the distance measurement information received from the portable device 100. Furthermore, the server 300 obtains the time ΔT2 based on the distance measurement information received from the communication unit 200. Furthermore, the server 300 calculates the distance measurement value based on the obtained time ΔT1 and time ΔT2.

According to this configuration, the communication unit 200 does not have to calculate the distance measurement value. Hence, a process load of the communication unit 200 is reduced. Furthermore, according to this configuration, the portable device 100 does not have to directly transmit the data signal that includes the information indicating ΔT1 to the communication unit 200. Consequently, taking into account that communication between the portable device 100 and the communication unit 200 can be eavesdropped, it is possible to improve a security level. Furthermore, the communication unit 200 does not have to receive the data signal, so that it is possible to reduce a reception standby period. Consequently, it is possible to suppress power consumption of the communication unit 200.

In this regard, reception standby refers to a state where a desired signal can be obtained and processed. The state where the signal can be obtained and processed may mean starting importing to a processing device a signal received via an antenna. Furthermore, the state where the signal can be obtained and processed may mean starting executing various subsequent processes on the signal imported to the processing device. Note that the state where the signal can be obtained and processed may mean receiving a desired signal via the antenna in a case where importing of the signal to the processing device is configured to be executed when reception of the desired signal via the antenna is detected.

Examples of the various subsequent processes include a process of deciding whether or not the signal received via the antenna is the desired signal, and a process of checking information included in this signal.

A state where reception standby is performed is also referred to as a reception standby state. Furthermore, a period of the reception standby time is also referred as a reception standby period.

The distance measurement process according to the present embodiment has been described above.

Furthermore, the server 300 may perform decision that is based on the distance measurement value that indicates the distance between the portable device 100 and the communication unit 200 as the process according to the distance measurement information. An example of the decision based on the distance measurement value is to authenticate the portable device 100 based on the distance measurement value. For example, the server 300 calculates the distance measurement value based on the distance measurement information. Furthermore, the server 300 decides success of authentication when the distance measurement value is less than a predetermined threshold. On the other hand, the server 300 decides failure of authentication when the distance measurement value is the predetermined threshold or more. According to this configuration, the communication unit 200 does not have to perform a process of deciding whether or not authentication succeeds, so that it is possible to reduce the process load of the communication unit 200.

The server 300 transmits information that indicates a result of the process performed according to the distance measurement information to at least one of the portable device 100 and the communication unit 200. For example, the server 300 transmits information that indicates whether or not authentication succeeds based on the distance measurement value to at least one of the portable device 100 and the communication unit 200. According to this configuration, the communication unit 200 can obtain the information that indicates whether or not the authentication succeeds without deciding whether or not the authentication succeeds based on the distance measurement value. The communication unit 200 does not have an arithmetic logic for authentication, so that it is possible to improve a security level. Furthermore, according to this configuration, the portable device 100 can obtain the information that indicates whether or not authentication succeeds not from the communication unit 200 but from the server 300. Consequently, even when communication between the portable device 100 and the communication unit 200 is eavesdropped, it is possible to secure a security level.

### (4) Flow of Process

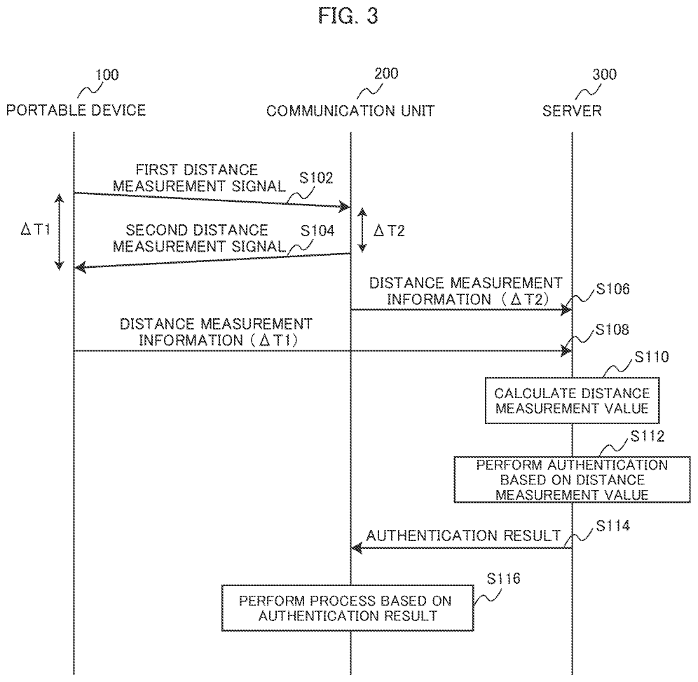

FIG. 3 is a sequence diagram illustrating an example of a flow of a process executed by the system 1 according to the present embodiment. As illustrated in FIG. 3, the portable device 100, the communication unit 200, and the server 300 are involved in this sequence.

As illustrated in FIG. 3, the second wireless communication section 120 of the portable device 100 first transmits the first distance measurement signal (step S102). For example, the first distance measurement signal may be transmitted as a signal that uses the UWB.

Next, when receiving the first distance measurement signal from the portable device 100, the second wireless communication section 220 of the communication unit 200 transmits the second distance measurement signal as a response to the first distance measurement signal (step S104). For example, the second distance measurement signal may be transmitted as a signal that uses the UWB.

In this case, the control section 240 of the communication unit 200 measures the time ΔT2 from the reception time of the first distance measurement signal to the transmission time of the second distance measurement signal in the communication unit 200. Furthermore, the first wireless communication section 210 of the communication unit 200 transmits the distance measurement information that includes the information indicating the time ΔT2 (step S106). This distance measurement information is received by the communication section 310 of the server 300 via the base station.

On the other hand, when receiving the second distance measurement signal from the communication unit 200, the control section 140 of the portable device 100 measures the time ΔT1 from the transmission time of the first distance measurement signal to the reception time of the second distance measurement signal in the portable device 100. Furthermore, the first wireless communication section 110 of the portable device 100 transmits the distance measurement information that includes the information indicating the time ΔT1 (step S108). This distance measurement information is received by the communication section 310 of the server 300 via the base station.

Furthermore, the control section 330 of the server 300 calculates the distance measurement value that indicates the distance between the portable device 100 and the communication unit 200 based on the time ΔT1 and the time ΔT2 (step S110). More specifically, the control section 330 calculates a one-way signal propagation time by dividing a result of ΔT1−ΔT2 by 2. Furthermore, the control section 330 calculates the distance measurement value that indicates the distance between the portable device 100 and the communication unit 200 by multiplying this propagation time with a signal speed.

Next, the control section 330 of the server 300 performs authentication based on the calculated distance measurement value (step S112). For example, the control section 330 decides success of authentication when the distance measurement value is less than a predetermined threshold. On the other hand, the control section 330 decides failure of authentication when the distance measurement value is the predetermined threshold or more.

Next, the communication section 310 of the server 300 transmits information that indicates an authentication result to the communication unit 200 (step S114).

Furthermore, when the information that indicates the authentication result is received, the control section 240 of the communication unit 200 performs a process based on the authentication result (step S116). When, for example, information that indicates success of authentication is received as the information that indicates the authentication result, the control section 240 of the communication unit 200 unlocks the door lock of the vehicle 202 or starts the engine, and makes the vehicle 202 available for the user.

### 3. Supplementary Explanation

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

### First Modified Example

Although the above embodiment has described the example where the server 300 transmits information that indicates whether or not authentication succeeds as information that indicates the result of the process performed according to the distance measurement information, the present invention is not limited to this example.

For example, the server 300 may transmit the distance measurement value calculated based on the distance measurement information as the information that indicates the result of the process performed according to the distance measurement information. In an example, the server 300 may transmit the distance measurement value to the communication unit 200. According to this configuration, the communication unit 200 can perform decision based on the distance measurement value. In another example, the server 300 may transmit the distance measurement value to the portable device 100. According to this configuration, the portable device 100 can perform decision based on the distance measurement value.

### Second Modified Example

Although the above embodiment has described the example where a transmission destination of information transmitted from the server 300 is at least one of the portable device 100 and the communication unit 200, the present invention is not limited to this example.

The server 300 may transmit the information that indicates the result of the process performed according to the distance measurement information to another device other than the portable device 100 and the communication unit 200. For example, the server 300 may transmit the information that indicates whether or not authentication succeeds based on the distance measurement value to the another device other than the portable device 100 and the communication unit 200. An example of the another device is the another communication unit 200 that is mounted on the another vehicle 202 near the vehicle 202 on which the communication unit 200 is mounted. According to this configuration, the plurality of communication units 200 can share the information that indicates the result of the process performed according to distance measurement information.

### Third Modified Example

Although the above embodiment has described the example where the information transmitted by the server 300 is the information that indicates the result of the process performed according to the distance measurement information, the present invention is not limited to this example.

The server 300 may transmit the distance measurement information to at least one of the portable device 100 and the communication unit 200. In other words, the server 300 may transmit at least one of the distance measurement information and the information that indicates the result of the process performed according to the distance measurement information to at least one of the portable device 100 and the communication unit 200. In an example, the server 300 may transmit the distance measurement information received from the portable device 100 to the communication unit 200. According to this configuration, the communication unit 200 can perform the process according to the distance measurement information obtained by the portable device 100. In another example, the server 300 may transmit the distance measurement information received from the communication unit 200 to the portable device 100. According to this configuration, the portable device 100 can perform the process according to the distance measurement information obtained by the communication unit 200.

Furthermore, according to the second modified example, the server 300 may transmit the distance measurement information to the another device other than the portable device 100 and the communication unit 200. In other words, the server 300 may transmit at least one of the distance measurement information and the information that indicates the result of the process performed according to the distance measurement information to the another device other than the portable device 100 and the communication unit 200. In an example, the server 300 may transmit the distance measurement information received from each of the portable device 100 and the communication unit 200 to the another device. According to this configuration, the another device can perform the process according to the distance measurement information obtained from each of the portable device 100 and the communication unit 200.

### Fourth Modified Example

Although the above embodiment has cited the time ΔT1, time information for calculating the time ΔT1, the time ΔT2, and time information for calculating the time ΔT2 as the distance measurement information, the present invention is not limited to this example.

The distance measurement information may include the distance measurement value that is calculated based on the information obtained by transmitting and receiving the distance measurement signal, and indicates the distance between the portable device 100 and the communication unit 200. For example, the time ΔT2 may be a fixed value. That is, the communication unit 200 may transmit the second distance measurement signal at a timing at which the time ΔT2 that is the fixed value passes after receiving the first distance measurement signal. In this case, the portable device 100 can calculate the distance measurement value based on the measured time ΔT1 and ΔT2 that is the fixed value. Furthermore, the portable device 100 may transmit the calculated distance measurement value as the distance measurement information to the server 300. According to this configuration, the server 300 does not have to calculate the distance measurement value, so that a process load of the server 300 is reduced.

### Other Supplementary Explanation

For example, although the above embodiment has described the example where the portable device 100 transmits the first distance measurement signal, the present invention is not limited to this example. For example, the communication unit 200 may transmit the first distance measurement signal. In this case, when receiving the first distance measurement signal, the portable device 100 transmits the second distance measurement signal as a response to the first distance measurement signal. Furthermore, the portable device 100 transmits to the server 300 the distance measurement information that includes the information that indicates the time ΔT2 from the reception time of the first distance measurement signal to the transmission time of the second distance measurement signal or the information that indicates the reception time of the first distance measurement signal and the transmission time of the second distance measurement signal. On the other hand, the communication unit 200 transmits to the server 300 the distance measurement information that includes the information that indicates the time ΔT1 from the transmission time of the first distance measurement signal to the reception time of the second distance measurement signal or the information that indicates the transmission time of the first distance measurement signal and the reception time of the second distance measurement signal.

For example, although the above embodiment has described the example where the communication unit 200 transmits the time ΔT2 or the time information for calculating the time ΔT2 as the distance measurement information to the server 300, the present invention is not limited to this example. For example, the time ΔT2 may be a fixed value. In this case, the communication unit 200 may not transmit the distance measurement information to the server 300. The server 300 can calculate the distance measurement value based on the time ΔT1 that is indicated by the distance measurement information received from the portable device 100, and the time ΔT2 that is the fixed value.

For example, although the above embodiment has described the example where the distance measurement signal is transmitted and received by using the UWB, the present invention is not limited to this example. In an example, Wi-Fi (registered trademark), Bluetooth Low Energy (BLE and registered trademark), infrared ray, and Near Field Communication (NFC) may be used to transmit and receive distance measurement signals.

For example, although the above embodiment has described the example where the server 300 obtains the distance measurement information obtained by transmitting and receiving the distance measurement signal between the two devices of the portable device 100 and the communication unit 200, and performs the process according to the distance measurement information, the present invention is not limited to this example. The server 300 may obtain the distance measurement information obtained by transmitting and receiving distance measurement signals between three or more devices, and perform the process according to the obtained distance measurement information.

For example, although the above embodiment has described the example where the portable device 100 is the first communication device, and the communication unit 200 is the second communication device, the present invention is not limited to this example. For example, the portable device 100 may be the second communication device, and the communication unit 200 may be the first communication device. That is, one of the first communication device and the second communication device only needs to be mounted on a vehicle, and other one of the first communication device and the second communication device only needs to be a device carried by a user of the vehicle.

For example, although the above embodiment has described the example where the communication unit 200 is the communication device that is mounted on the vehicle, the present invention is not limited to this example. The communication unit 200 may be mounted on arbitrary movable bodies such as airplanes and ships other than vehicles. In this regard, the movable bodies are devices that move.

For example, although the above embodiment has described the example where the present invention is applied to a smart entry system, the present invention is not limited to this example. The present invention is applicable to arbitrary systems. The present invention is applicable to, for example, pairs of two arbitrary devices of portable devices, vehicles, smartphones, drones, houses, and home electric appliances. Note that the pairs may include the two devices of the same type, and include the two devices of different types.

Note that, a series of processes performed by the devices described in this specification may be achieved by any of software, hardware, and a combination of software and hardware. A program that configures software is stored in advance in, for example, a recording medium (non-transitory medium) installed inside or outside the devices. In addition, for example, when a computer executes the programs, the programs are read into random access memory (RAM), and executed by a processor such as a CPU. The recording medium may be a magnetic disk, an optical disc, a magneto-optical disc, flash memory, or the like. Alternatively, the above-described computer program may be distributed via a network without using the recording medium, for example.

Further, in the present specification, the processes described using the flowcharts and the sequence diagrams are not necessarily executed in the order illustrated in the drawings. Some processing steps may be executed in parallel. In addition, additional processing steps may be employed and some processing steps may be omitted.

### REFERENCE SIGNS LIST

1 system
100 portable device
110 first wireless communication section
120 second wireless communication section
130 storage section
140 control section
200 communication unit
202 vehicle
210 first wireless communication section
220 second wireless communication section
230 storage section
240 control section
300 server
310 communication section
320 storage section
330 control section

1. A control device comprising a control section configured to obtain distance measurement information, and perform a process according to the obtained distance measurement information, the distance measurement information being information that is obtained by transmitting and receiving a distance measurement signal between at least two communication devices, and the distance measurement signal being a signal that is transmitted and received to measure a distance between the two communication devices.

2. The control device according to claim 1, wherein the distance measurement information is the information that is obtained when a first communication device that is one of the two communication devices transmits a first distance measurement signal, an other second communication device receives the first distance measurement signal, the second communication device transmits a second distance measurement signal as a response to the first distance measurement signal, and the first communication device receives the second distance measurement signal.

3. The control device according to claim 2, wherein the distance measurement information includes information that indicates a time from a transmission time of the first distance measurement signal to a reception time of the second distance measurement signal in the first communication device.

4. The control device according to claim 2, wherein the distance measurement information includes information that indicates a transmission time of the first distance measurement signal and a reception time of the second distance measurement signal in the first communication device.

5. The control device according to claim 2, wherein the distance measurement information includes information that indicates a time from a reception time of the first distance measurement signal to a transmission time of the second distance measurement signal in the second communication device.

6. The control device according to claim 2, wherein the distance measurement information includes information that indicates a reception time of the first distance measurement signal and a transmission time of the second distance measurement signal in the second communication device.

7. The control device according to claim 2, wherein the distance measurement information includes a distance measurement value that is calculated based on information obtained by transmitting and receiving the distance measurement signal, and indicates the distance between the first communication device and the second communication device.

8. The control device according to claim 2, wherein the control section performs calculation of a distance measurement value indicating the distance between the first communication device and the second communication device based on the distance measurement information as the process according to the distance measurement information.

9. The control device according to claim 7, wherein the control section performs decision that is based on the distance measurement value indicating the distance between the first communication device and the second communication device as the process according to the distance measurement information.

10. The control device according to claim 2, wherein the control section transmits at least one of the distance measurement information and information that indicates a result of the process performed according to the distance measurement information to at least one of the first communication device and the second communication device.

11. The control device according to claim 2, wherein the control section transmits at least one of the distance measurement information and information that indicates a result of the process performed according to the distance measurement information to another device other than the first communication device and the second communication device.

12. The control device according to claim 2, wherein
one of the first communication device and the second communication device is mounted on a vehicle, and
other one of the first communication device and the second communication device is a device that is carried by a user of the vehicle.

13. A communication device comprising:
a wireless communication section configured to perform wireless communication with another communication device; and
a control section configured to control a process of transmitting distance measurement information to a control device configured to execute communication with each of the communication device and the another communication device, the distance measurement information being information that is obtained by transmitting and receiving a distance measurement signal between the wireless communication section and the another communication device, and the distance measurement signal being a signal that is transmitted and received to measure a distance between the two communication devices.

14. An information processing method comprising obtaining distance measurement information, and performing a process according to the obtained distance measurement information, the distance measurement information being information that is obtained by transmitting and receiving a distance measurement signal between at least two communication devices, and the distance measurement signal being a signal that is transmitted and received to measure a distance between the two communication devices.

15. (canceled)
